(19) United States
(12) Patent Application Publication
(10) Pub. No.: US 2020/0080604 A1
(43) Pub. Date: Mar. 12, 2020

(54) TOOL FOR REMOVING BRAKE SHOE KEY

(71) Applicant: Dusty C. Schwenke, Harlem, MT (US)

(72) Inventor: Dusty C. Schwenke, Harlem, MT (US)

(21) Appl. No.: 16/266,051

(22) Filed: Feb. 2, 2019

Related U.S. Application Data
(60) Provisional application No. 62/730,207, filed on Sep. 12, 2018.

(51) Int. Cl. F16D 65/00; B25B 27/04

(52) U.S. Cl. CPC F16D 65/0043; B25B 27/04

(57) ABSTRACT

A tool for removing a brake shoe key having a main member and a pin. The main member has an elongated section with one end connected to a receiver. The receiver forms a trough for receiving a brake shoe key. The longitudinal axis of the trough is parallel to the longitudinal axis of the elongated section of the main member, which has at least two holes that for receiving an end of a pry bar. The first side wall and the second side wall of the trough each has an opening that is configured to allow the elongated body of the pin to pass through both openings simultaneously. The first side wall is contiguous with the elongated section of the main member. The floor of the trough forms a front side of the tool, which has a slot for receiving a tip of a brake shoe key.

### CROSS-REFERENCE TO RELATED APPLICATION

Pursuant to 35 U.S.C. § 119(e), this application claims priority back to U.S. patent application Ser. No. 29/664,173 filed on Sep. 21, 2018.

### BACKGROUND OF THE INVENTION

### 1. Field of the Invention

The present invention relates generally to the field of hand tools used on rail cars, and more specifically, to a hand tool designed to facilitate the removal of a key from a brake shoe.

### 2. Description of the Related Art

Brake shoes on rail cars are secured to the brake beam with a key. When a brake shoes wears and needs to be replaced, the key must be removed before the brake shoe can be removed and replaced. These keys may rust, become bent, or become stuck as a result of dirt and debris in the brake shoe. These keys are also difficult to remove due to their positioning inside the frame of the rail car wheel set. Obtaining access to the brake shoe key at the right angle is challenging, and removal of the key from the brake shoe poses safety risks to railroad employees.

Currently, there is no good tool for removing keys from rail car brake shoes. Employees typically use a pry bar and try to shimmy the key out of the brake shoe by going through the window in the side of the truck frame. Using a pry bar to remove the brake shoe key is both difficult and time-consuming. The ergonomic design of the present invention eliminates overexertion by promoting better body position, thereby decreasing the risk of operator injury.

There is a dearth of prior art in the area of tools designed for removing keys from railcar brake shoes. U.S. Pat. No. 6,233,803 (Anderson et al., 2001) discloses a steering arm assembly for use with railway car trucks having pivotal frames and brake systems. The steering arm assembly includes a sub-assembly with top and bottom surfaces and top and bottom holes that define a vertical open path between the top and bottom surfaces, the vertical open path being positioned above the brake shoe key. The patent covers a method of removing a brake shoe from the brake beam comprising the steps of providing a side access hole in each sub-assembly, inserting a tool through a side frame window and through the side access hole, applying the tool to the brake shoe key to move it upwardly through the vertical open path formed by the top and bottom holes in the sub-assembly, and moving the brake shoe key upwardly through the vertical open path. This particular invention is directed toward solving the problem of removing brake shoe keys from railway cars that are equipped with steering arms. Nothing in this patent describes or illustrates the specific tool used to remove the brake shoe key; it is simply described as a “prying tool.”

The following patents involve tools for use with railroad cars but are not designed specifically for use in removing keys from brakes shoes, nor are they structurally similar to the present invention.

U.S. Pat. No. 5,481,950 (Browning, 1996) provides a multipurpose tool for use with railroad cars. The tool has a rigid head extending laterally from an adjustable handle. The handle has two opposing concave surfaces and an elongate slot that is aligned with the longitudinal axis of the handle. One of the concave surfaces forms a point where it joins the outer edge of the head to define a point adapted to fit within a hole in a knuckle of a railroad car. The tool is used to set and release handbrakes without having to climb on equipment or cross between cars. It is also used to control the retainer valves on air brakes and to open and close the knuckles of the coupling mechanisms used to connect adjacent railway cars.

U.S. Pat. No. 8,434,802 (Lofley, Sr. et al., 2013) and U.S. Pat. No. 8,469,426 (Lofley, Sr. et al., 2013) describe an extension tool comprised of a first pole and a second pole that is slidably received within the first pole. A claw is secured to an end of the second pole for engaging either a knuckle coupler or a wheel brake of a railroad car. The claw includes a pole receiver and a locking bore.

### BRIEF SUMMARY OF THE INVENTION

The present invention is a tool for removing a brake shoe key comprising: a main member; and a pin; wherein the main member comprises an elongated section with a distal end and a proximal end; wherein the proximal end of the elongated second of the main member is connected to a receiver; wherein the receiver comprises a trough that is configured to receive a brake shoe key; wherein the elongated section of the main member has a longitudinal axis, the trough has a longitudinal axis, and the longitudinal axis of the trough is parallel to the longitudinal axis of the elongated section of the main member; wherein the elongated body of the main member comprises at least two holes configured to receive an end of a pry bar; wherein the at least two holes in the elongated body of the main member are spaced along a longitudinal axis of the elongated body of the main member; wherein the pin comprises an elongated body; and wherein the first side wall and the second side wall of the trough each comprises an opening that is configured to allow the elongated body of the pin to pass through both openings simultaneously.

In a preferred embodiment, the trough of the receiver is formed by a first side wall, a second side wall and a floor; wherein the side walls are parallel to each other, and the floor is perpendicular to and situated between the first side wall and the second side wall; wherein the first side wall is contiguous with the elongated section of the main member; wherein the floor of the trough forms a front side of the tool; wherein the front side of the tool comprises a slot that is configured to receive a tip of a brake shoe key; and wherein the slot in the floor of the trough extends laterally across the front side of the tool. Preferably, the first side wall and the second side wall of the trough are identical in size and shape; and each of the first and second side walls comprises a proximal end that is rounded. The trough comprises a front end and a rear end, and both the front end and the rear end of the trough are preferably open.

In a preferred embodiment, the elongated body of the main member comprises a front edge and a rear edge; and the front edge and the rear edge of the elongated body of the main member are parallel to each other. Preferably, the distal end of the elongated body of the main member is rounded. In a preferred embodiment, the receiver has a length; the elongated body of the main member has a length; and the length of the receiver is approximately one-third of the length of the elongated section of the main member. In one embodiment, the pin is attached to the elongated body of the main member with a cable.

### BRIEF DESCRIPTION OF THE DRAWINGS

FIG. 1 is a first perspective view of the present invention.

FIG. 2 is a second perspective view of the present invention.

FIG. 3 is a third perspective view of the present invention.

FIG. 4 is a side view of the present invention.

FIG. 5 is a perspective view of the brake shoe and key.

FIG. 6 is a perspective view of the wheel set and side frame of a railcar.

FIG. 7 is a perspective view of the brake shoe and key shown through the window in the side frame.

FIG. 8 is a perspective view of the brake shoe and key shown in relation to the wheel with the side frame removed.

FIG. 9 is a perspective view of the brake shoe and key shown with the present invention in a first initial position.

FIG. 10 is a perspective view of the brake shoe and key shown with the present invention in a first subsequent position.

FIG. 11 is a perspective view of the brake shoe and key shown with the present invention in a second initial position.

FIG. 12 is a perspective view of the brake shoe and key shown with the present invention in a second subsequent position.

### REFERENCE NUMBERS

1 Main member
2 Pin
3 Cable
4 Elongated section (of main member)
4a Circular apertures (in elongated section)
5 Receiver
6 Hole (in elongated section)
7 Trough (of receiver)
8 First side wall (of receiver)
9 Second side wall (of receiver)
10 Floor (of receiver)
11 Opening (in side wall)
12 Head (of pin)
12b Collar (of pin)
13 Elongated body (of pin)
14 Brake shoe
15 Key
16 Brake beam head
17 Rounded corner (of side wall)
18 Slot (in receiver)
19 Tip (of key)
20 Wheel
21 Side frame
22 Window (in side frame)

### DETAILED DESCRIPTION OF INVENTION

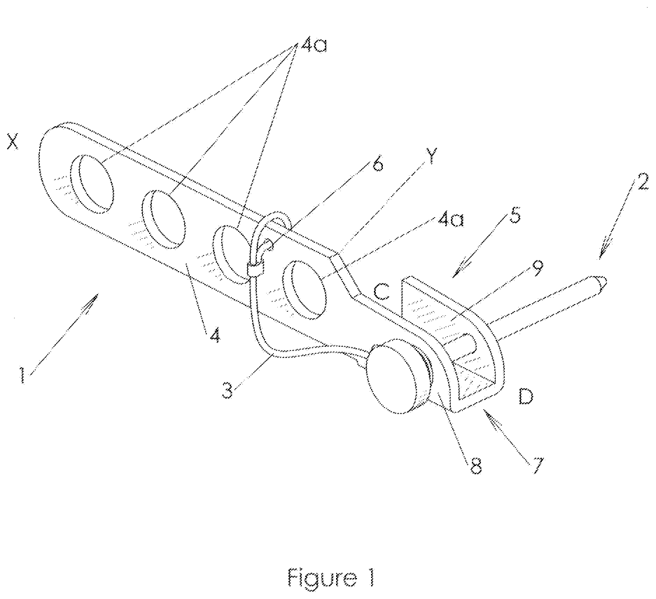

FIG. 1 is a first perspective view of the present invention. As shown in this figure, the present invention is comprised of a main member 1 and a pin 2. In this figure, the pin 2 is shown connected to the main member 1 with a cable 3, but the pin may be connected to the main member with a cord, rope, strap, bracket or clip, or it may not be physically connected to the main member at all. The cable 3 is shown in FIG. 1 and then omitted from subsequent figures for clarity.

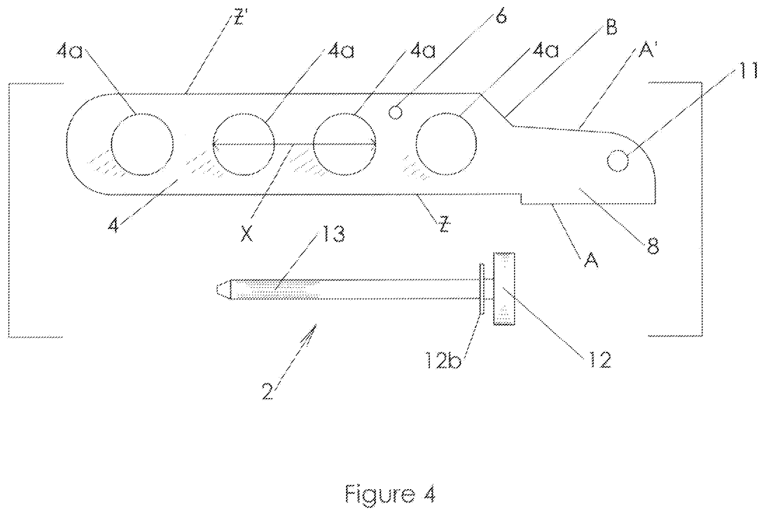

The main body comprises an elongated section 4 with a distal end X and a proximal end Y. The distal end of the elongated section 4 is preferably rounded, as shown. The proximal end of the elongated section 4 is connected to receiver 5. The elongated section 4 preferably comprises tour circular apertures 4a evenly spaced along the longitudinal axis of the elongated section 4. Each aperture 4a is configured to receive an end of a pry bar. All four apertures 4a are preferably the same size, with the same diameter and circumference. In a preferred embodiment, the diameter of a single aperture 4a is greater than half the distance from the distal edge of one aperture to the distal edge of an adjacent aperture (this distance is identified as “X” on FIG. 4). The elongated section 4 has a front edge Z and a rear edge Z′ (see FIG. 4). A hole 6 in the elongated section 4 is situated proximate to the rear edge Z′ and configured so that the cable 3 may lit through it. This hole 6 is preferably situated between the two circular apertures 4a closest to the receiver 5. The distance between the center point of each aperture 4a and the front edge Z is the same as the distance between the center point and the rear edge Z′; this distance is approximately equal to the diameter of a single aperture (see FIG. 4). The front edge Z and rear edge Z′ are preferably parallel to each other.

The receiver 5 is comprised of a trough 7 formed by two side walls 8, 9 and a floor 10. The first side wall 8 is contiguous with the elongated section 4 (preferably, the first side wall 8 and elongated section 4 are made of a single piece of metal), and the trough 7 is open to the rear of the tool (the floor 10 of the trough 7 forms the front side of the tool). The side walls 8, 9 are identical in size and shape, and the rear corner of each side wall is rounded, as shown: these rounded corners 17 are critical to the performance of the tool in that they allow the tool to pivot against the brake beam head. An opening 11 in the rear corner of each side wall is configured to allow the pin 2 to fit through it. These openings 11 are laterally aligned so that the pin may fit through both openings 11. The trough 7 has an inner width (measured laterally, in the same direction as the orientation of the pin 2), and this inner width is slightly greater than the width of the brake shoe key so that the brake shoe key fits into the trough.

The receiver 5 comprises a front edge A and a rear edge A′, which is sloped downward from the distal end to the proximal end (rounded corner at an angle of approximately fifteen degrees (15°). The distance between the front edge A and the rear edge A′ at the distal end of the receiver along its entire length is less than the distance between the front edge Z and the rear edge Z′ of the elongated body 4. An angled edge B joins the rear edge Z′ to the rear edge A′; the angled edge B is at an angle of approximately forty-five degrees (45°) relative to the rear edge Z′. The distal C and proximal D ends of the trough are open, and the floor 10 is perpendicular to the side walls 8, 9. The pin 2 comprises a head 12, a collar 12b, and an elongated body 13. The elongated body 13 of the pin 2 is configured to fit through the openings 1.

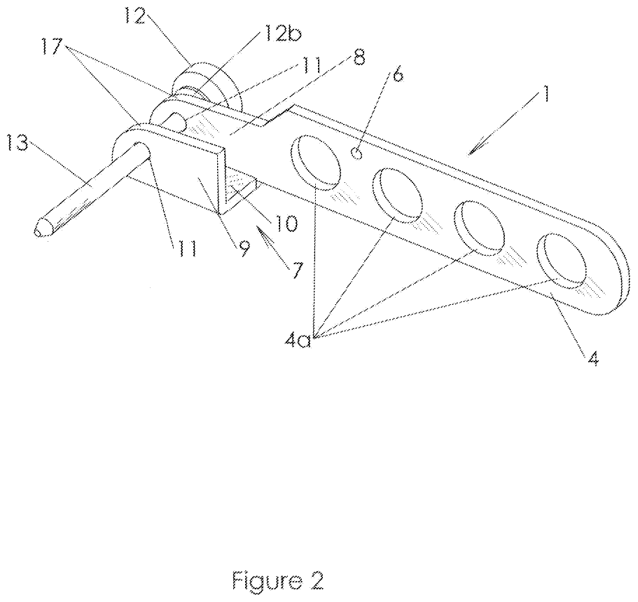

FIG. 2 is a second perspective view of the present invention. As shown in this figure, the distal end of the second side wall 9 (that is, the end opposite the rounded, rear corner) preferably forms a straight edge that is perpendicular to the longitudinal axis of the trough 7. The longitudinal axis of the trough 7 is parallel to the longitudinal axis of the elongated section 4.

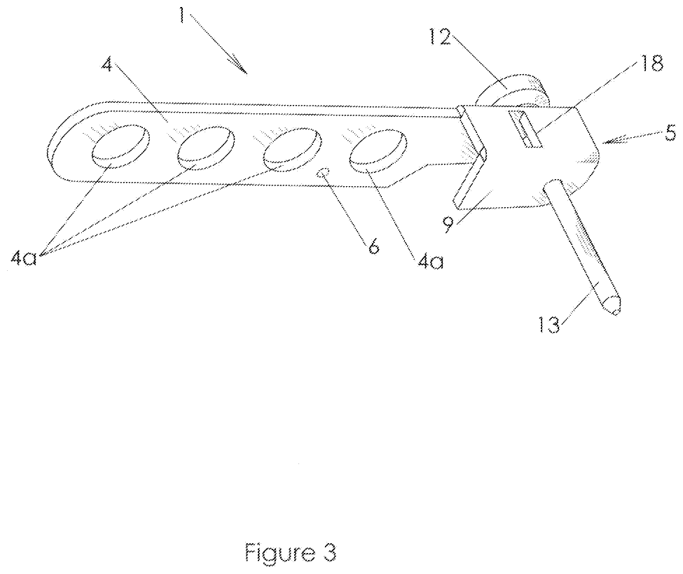

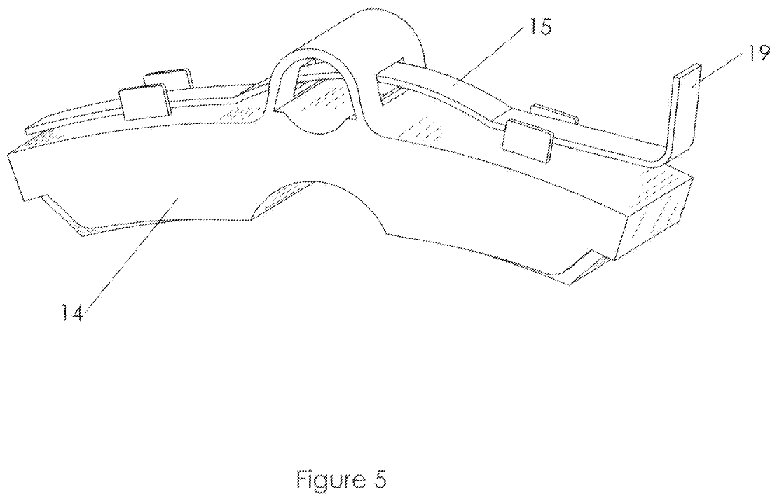

FIG. 3 is a third perspective view of the present invention. As shown in this figure, the front of the receiver 5 (which is formed by the floor 10 of the trough 7) comprises a slot 18. The slot 18 extends laterally across nearly the entire front surface of the receiver 5 and is configured to receive the tip 19 of the brake key (see FIG. 5).

FIG. 4 is a side view of the present invention. Note that the length of the receiver 5 (measured from distal end C to proximal end D) is approximately one-third the length of the elongated section 4 (measured from distal end X to proximal end Y).

FIG. 5 is a perspective view of the brake shoe and key. The brake shoe 14 and key 15 are not part of the present invention, but the present invention acts on the brake shoe key. As noted above, the key comprises a tip 19 that fits into the slot 18 in the front of the receiver 5. The tip 19 also fits into the trough 7.

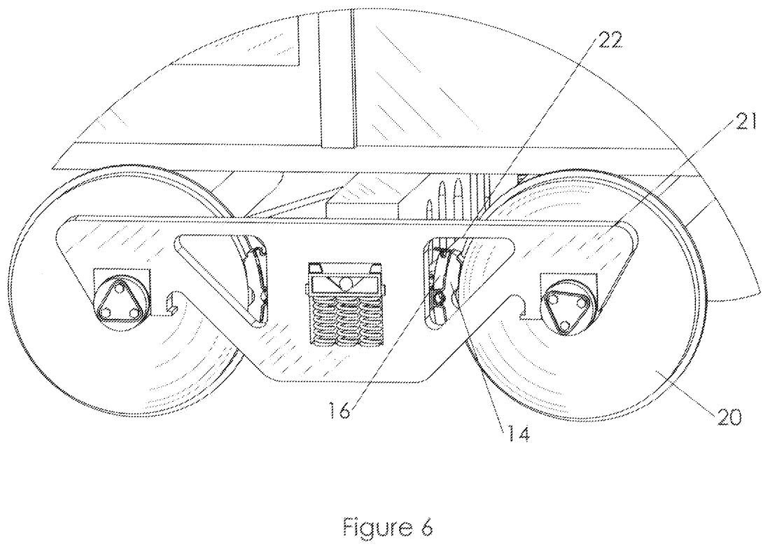

FIG. 6 is a perspective view of the wheel set and side frame of a railcar. The present invention is not limited to use on any particular type of railcar; in fact, it is specifically designed to be used with different types and sizes of railcars, including, but not limited to, hopper, tank, box, flat, gondola, and intermodal railcars. This figure shows the location of the brake shoe 14 and brake beam head 16 relative to the wheel 20. Note that the side frame 21 comprises a window 22 through which the brake shoe key 15 may be accessed. The brake shoe key 15 may also be accessed over the top of the side frame 21. The present invention is design to be used via either access point (through the window or over the top of the frame). The top two holes of the elongated section (that is, the two holes closest to the distal end X of the elongated section) are typically used when the tool is accessed over the top of the frame, and the bottom two holes of the elongated section (that is, the two holes closest to the receiver 5) are typically used when the tool is accessed through the window. The availability of four different holes to choose from allows the operator to obtain the best angle depending on access point and car load.

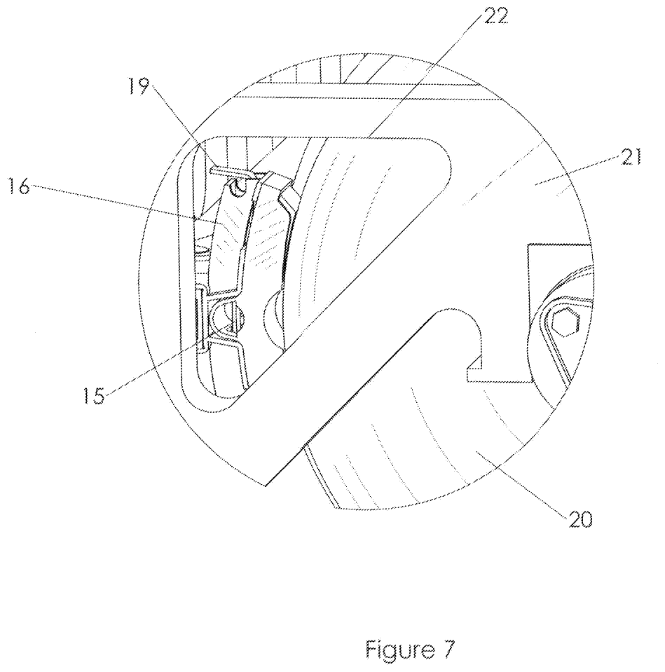

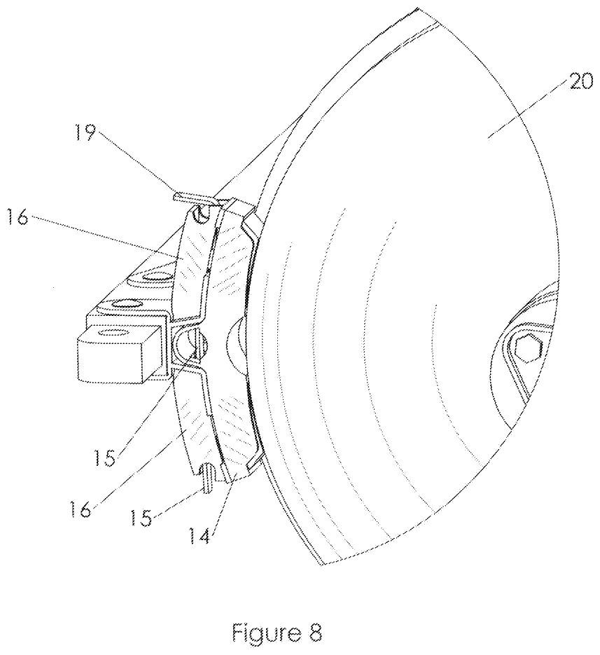

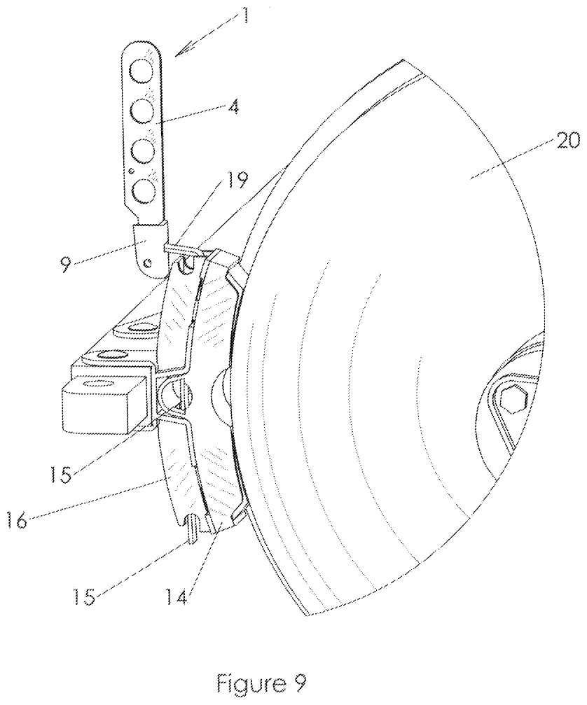

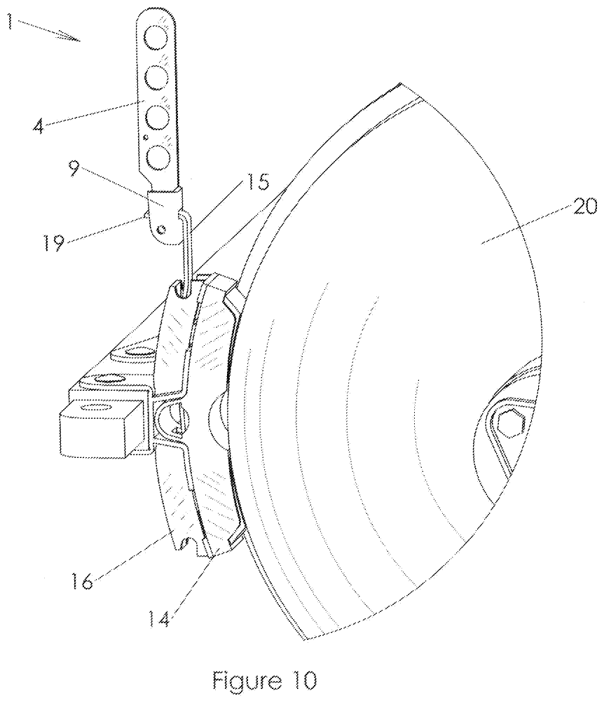

FIG. 7 is a perspective view of the brake shoe and key shown through the window in the side frame. FIG. 8 is a perspective view of the brake shoe and key shown in relation to the wheel with the side frame removed. As shown in these two figures, the key 15 secures the brake shoe 14 to the brake beam head 16. Ideally, the key 15 would be in the position shown in this figure, but in practice, the key 15 may be jammed down into the brake beam head 16, necessitating use of the present invention in the manner shown in FIGS. 9 and 10.

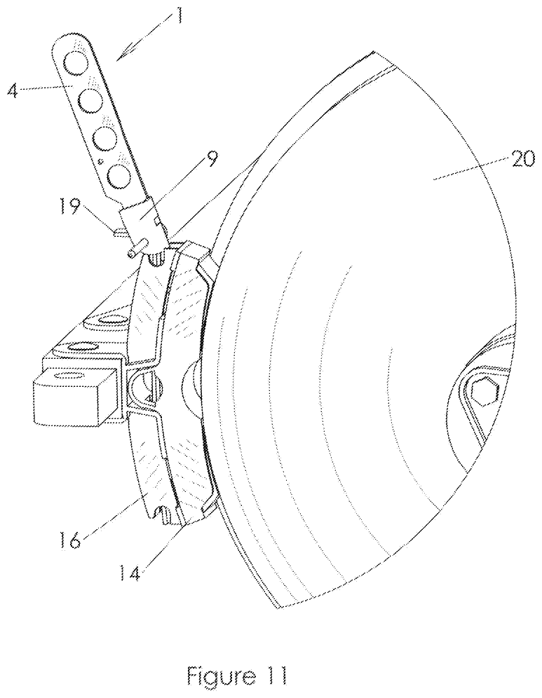

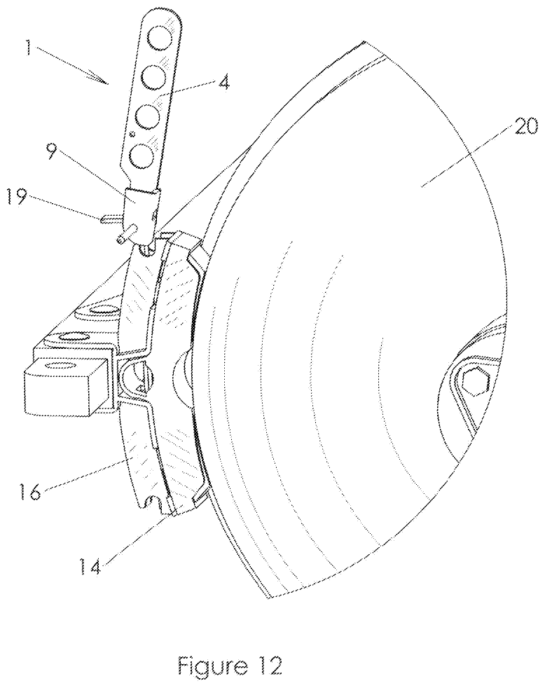

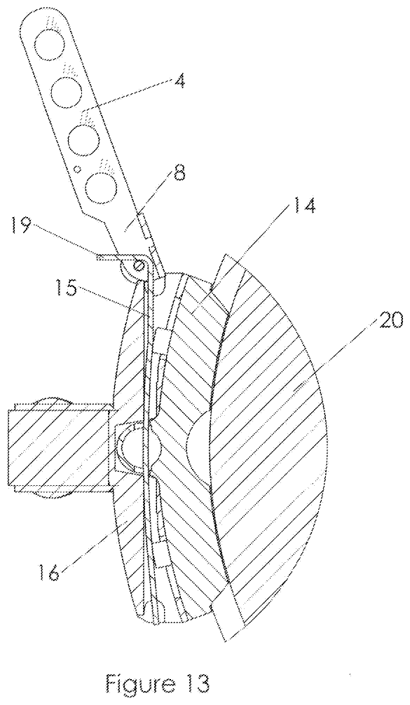

As explained below, the tool may be used in two different configurations. There is no other tool available that provides such versatility of use. FIG. 9 is a perspective view of the brake shoe and key shown with the present invention in a first initial position. In this configuration, the invention is used to pry the key 15 out of the brake shoe 14 when the tip 19 of the key 15 is too close to the top of the brake beam head 16 to use the invention in the second configuration (shown in FIGS. 11 and 12). In this configuration, the tip 19 is inserted into the slot 18, a pry bar (not shown) is inserted into any one of the apertures 4a, and the tool is leveraged upward, to the position shown in FIG. 10.

FIG. 11 is a perspective view of the brake shoe and key shown with the present invention in a second initial position. In this configuration, the tip 19 is inserted into the trough 7, and the pin 2 is inserted into the opening 11. Note that the pin passes between the top end of the brake beam head 16 and the tip 19 of the key 15 so that as the tool is leveraged upward, the key is also forced upward. The rounded corners 17 allow the tool to pivot on the top of the brake beam head 16 (acting as a cam) to the position shown in FIG. 12, at which point the pry bar may be used to lift the key 15 out of the brake shoe 14. Note that the pin 2 may be inserted into the receiver 5 in either direction.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A tool for removing a brake shoe key comprising:
(a) a main member; and
(b) a pin;
wherein the main member comprises an elongated section with a distal end and a proximal end;
wherein the proximal end of the elongated second of the main member is connected to a receiver;
wherein the receiver comprises a trough that is configured to receive a brake shoe key;
wherein the elongated section of the main member has a longitudinal axis, the trough has a longitudinal axis, and the longitudinal axis of the trough is parallel to the longitudinal axis of the elongated section of the main member;
wherein the elongated body of the main member comprises at least two holes configured to receive an end of a pry bar;
wherein the at least two holes in the elongated body of the main member are spaced along a longitudinal axis of the elongated body of the main member;
wherein the pin comprises an elongated body; and
wherein the first side wall and the second side wall of the trough each comprises an opening that is configured to allow the elongated body of the pin to pass through both openings simultaneously.

2. The tool of claim 1, wherein the trough of the receiver is formed by a first side wall, a second side wall and a floor:
wherein the side walls are parallel to each other, and the floor is perpendicular to and situated between the first side wall and the second side wall;
wherein the first side wall is contiguous with the elongated section of the main member;
wherein the floor of the trough forms a front side of the tool;
wherein the front side of the tool comprises a slot that is configured to receive a tip of a brake shoe key; and
wherein the slot in the floor of the trough extends laterally across the front side of the tool.

3. The tool of claim 1, wherein the first side wall and the second side wall of the trough are identical in size and shape; and
wherein each of the first and second side walls comprises a proximal end that is rounded.

4. The tool of claim 1, wherein the trough comprises a front end and a rear end; and
wherein both the front end and the rear end of the trough are open.

5. The tool of claim 1, wherein the elongated body of the main member comprises a front edge and a rear edge; and
wherein the front edge and the rear edge of the elongated body of the main member are parallel to each other.

6. The tool of claim 1, wherein the distal end of the elongated body of the main member is rounded.

7. The tool of claim 1, wherein the receiver has a length;
wherein the elongated body of the main member has a length; and
wherein the length of the receiver is approximately one-third of the length of the elongated section of the main member.

8. The tool of claim 1, wherein the pin is attached to the elongated body of the main member with a cable.
